(19) United States
(12) Patent Application Publication
(10) Pub. No.: US 2006/0239172 A1
(43) Pub. Date: Oct. 26, 2006

(54) Object lens and optical pickup device incorporating same

(75) Inventor: Wen-Hsin Sun, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/391,073

(22) Filed: Mar. 28, 2006

(30) Foreign Application Priority Data
Apr. 22, 2005 (CN) 200510034364.2

(51) Int. Cl. G11B 7/135

(52) U.S. Cl. 369/112.23

(57) ABSTRACT

An object lens (10) includes a housing (107) having an inner layer, an electrically conductive liquid (103) having an electro-wetting effect with respect to the inner layer (102) of the housing, and an electrically insulating liquid (105) adjacent the electrically conductive liquid. The electrically conductive liquid and the electrically insulating liquid are hermetically contained in the housing and form two layers along a central axis of the housing. The electrically conductive liquid is capable of changing its form when a voltage is applied to the electrically conductive layer whereby the object lens has a second numerical aperture. The second numerical aperture is different from an original first numerical aperture of the object lens when there is no voltage applied to the electrically conductive layer. An optical pickup device using an object lens and compatible with plural optical recording mediums is also provided.

### BACKGROUND

The present invention relates to object lenses and optical pickup devices using the same and, more particularly, to an object lens compatible with multiple optical recording mediums.

An optical pickup device writes data to and/or reads data from a recording medium such as an optical disk. In such a device, a semiconductor laser is used for generating a light beam, and an object lens is used for focusing the light beam on the recording medium. A recording density of the recording medium corresponds to a size of the focused spot on the recording medium. To have an increased recording density, the size of the focused spot on the recording medium must be reduced. In general, a diametric size (S) of the focused spot is directly proportional to a wavelength (λ) of the light beam, and is inversely proportional to a numerical aperture (NA) of the object lens, as expressed by the formula: S≢λ/NA.

According to the formula, in order to reduce the spot size, the wavelength of the light beam must be reduced and/or the numerical aperture of the object lens must be increased. This has been demonstrated by the ongoing development of optical recording mediums. For example, the wavelength of read beams for compact disks (CDs) is about 780 nm, the wavelength of read beams for digital versatile disks (DVDs) is about 635-650 nm, and the wavelength of read beams for high-definition DVDs (HD-DVDs) and blu-ray disks is about 405-410 nm. Furthermore, the numerical aperture for CDs is 0.45, the numerical aperture for DVDs is 0.6, the numerical aperture for HD-DVDs is 0.65-0.8, and the numerical aperture for blu-ray disks is 0.85.

On the other hand, coma aberration (which occurs due to a tilting of the recording medium) is associated with a tilting angle of the recording medium, a refractive index of the recording medium substrate, a thickness of the recording medium substrate, and the numerical aperture of the object lens. To ensure an acceptable level of coma aberration with respect to the tilting of the recording medium for high-density recording, the thickness of the recording medium substrate is in general reduced accordingly. For example, CDs have a thickness of 1.2 mm, and DVDs have a thickness of 0.6 mm. Further, the thickness of many HD-DVDs is 0.6mm or less.

In an apparatus for high-density recording onto or playing from a medium such as an HD-DVD, a primary consideration is the compatibility of the apparatus with existing recording mediums including CDs and DVDs. Conventionally, there are two kinds of optical pickup devices that are used in multi-compatible home entertainment players. In the first kind of optical pickup device, an independent optical system is provided therein for each type of recording medium. That is, generally, the optical pickup device has at least three light sources and three object lenses for three recording mediums. This kind of optical pickup device needs many optical elements, and is unduly bulky and costly. In the second kind of optical pickup device, there are some common optical elements, for example, a common object lens. The common object lens includes a transparent piezoelectric element that deforms when a voltage is applied thereto. Thus, different numerical apertures can be achieved by applying different voltages to the object lens. However, the object lens made from piezoelectric material is somewhat resistant to distortion. A delay may occur during writing and/or reading, slowing the process of the optical pickup device writing and/or reading different types of recording mediums.

What is needed, therefore, is an object lens that can accurately and quickly focus light beams on different types of recording mediums, and an optical pickup device using the same.

### SUMMARY

A preferred embodiment provides an object lens including a housing having an inner layer, an electrically conductive liquid having an electro-wetting effect with respect to the inner layer of the housing, and an electrically insulating liquid adjacent the electrically conductive liquid. The electrically conductive liquid and the electrically insulating liquid are hermetically contained in the housing and form two layers along a central axis of the housing. The electrically conductive liquid is capable of changing its form when a voltage is applied to the electrically conductive layer whereby the object lens has a second numerical aperture. The second numerical aperture is different from an original first numerical aperture of the object lens when there is no voltage applied to the electrically conductive layer.

Another preferred embodiment provides an optical pickup device compatible with plural optical recording mediums. The optical pickup device includes a first and a second light sources, a first and a second photo detectors, a first and a second light splitters, a first beam splitter prism, and a liquid object lens. The first and the second light sources are used for emitting light beams with different wavelengths. The first and the second light splitters are used for allowing direct propagation of the light beams emitted from the light sources therethrough, and for deflecting the light beams reflected by the optical recording medium to the first and the second photo detectors, respectively. The first and the second photo detectors are adapted for detecting signals contained in the light beams they receive via the first and the second light splitters, respectively. The first beam splitter prism is used for transmitting or reflecting light beams according to their respective wavelengths. The liquid object lens defines at least two numerical apertures according to a controlled voltage applied thereto. The first light source, the first light splitter, the first beam splitter prism and the object lens are aligned along a first direction in that order. The second light source, the second light splitter, and the first beam splitter prism are aligned along a second direction in that order, and the second direction is substantially perpendicular to the first direction.

Other advantages and novel features will be drawn from the following detailed description of preferred embodiments together with the attached drawings, in which:

### BRIEF DESCRIPTION OF THE DRAWINGS

FIG. 1 is a schematic, cross-sectional view of an object lens according to a first preferred embodiment of the present invention;

FIG. 2 is a schematic, plan view of an optical pickup device according to a second preferred embodiment of the present invention together with a DVD and a CD, showing essential optical paths; and

FIG. 3 is a schematic, plan view of an optical pickup device according to a third preferred embodiment of the present invention together with a blu-ray disk, a DVD and a CD, showing essential optical paths.

### DETAILED DESCRIPTION OF PREFERRED EMBODIMENTS

Referring to FIG. 1, an object lens 10 according to a first preferred embodiment of the present invention is shown. The object lens 10 is a kind of liquid object lens, and mainly includes a housing 107 and two kinds of liquids 103, 105 hermetically contained in the housing 107. The housing 107 can be generally columnar. The two kinds of liquids 103, 105 do not mingle with each other.

The liquids 103, 105 have different optical properties, and particularly have different refraction indexes. The liquid 103 is an electrically conductive liquid, such as an electrically conductive aqueous solution. The liquid 105 is an electrically insulating liquid, such as an electrically insulating oily solution. Thus, the liquids 103, 105 form two layers along a central axis of the housing 107. An electrically conductive lubricant can further be sandwiched between the liquids 103, 105.

The housing 107 includes a top wall 108, a bottom wall 109 opposite to the top wall 108, and a sidewall. The sidewall includes a hydrophobic electrically conductive layer 102, a middle layer 104, and a packaging layer 101 in that order from an inside to an outside of the object lens 10. The top wall 108 and the bottom wall 109 can include glass material. The hydrophobic electrically conductive layer 102 has an electro-wetting effect. Thus, when a voltage is applied to the hydrophobic electrically conductive layer 102, a hydrophobicity of the hydrophobic electrically conductive layer 102 is decreased. The middle layer 104 is electrically insulative, and the packaging layer 101 is electrically conductive. The hydrophobic electrically conductive layer 102 and the packaging layer 101 respectively connect with an anode and a cathode of a controller 31 of the object lens 10. A capacitive property exists between the hydrophobic electrically conductive layer 102 and the packaging layer 101 when a voltage is applied therebetween.

When there is no voltage applied to the hydrophobic electrically conductive layer 102 and the packaging layer 101, a dome-shaped interface A is formed between the liquids 103, 105 because of action of surface tensions thereof. Thus, the object lens 10 has a first numerical aperture. The first numerical aperture can be set at 0.45, whereby the object lens 10 can focus a light beam of 780nm wavelength on an information-recording layer of a CD.

When a voltage is applied to the hydrophobic electrically conductive layer 102 and the packaging layer 101, a positive electric charge accumulates at the hydrophobic electrically conductive layer 102, and a negative electric charge accumulates at the packaging layer 101. Because the hydrophobic electrically conductive layer 102 with the positive charge has a lower hydrophobicity than without the charge, the liquid 103 tends to spread out along an inner surface of the hydrophobic electrically conductive layer 102. Therefore, a dome-shaped interface B is formed between the liquids 103, 105 because of action of surface tensions thereof. Thus, the object lens 10 has a second numerical aperture. The second numerical aperture can be set at 0.6, whereby the object lens 10 can focus a light beam of 650 nm wavelength on an information-recording layer of a DVD disk.

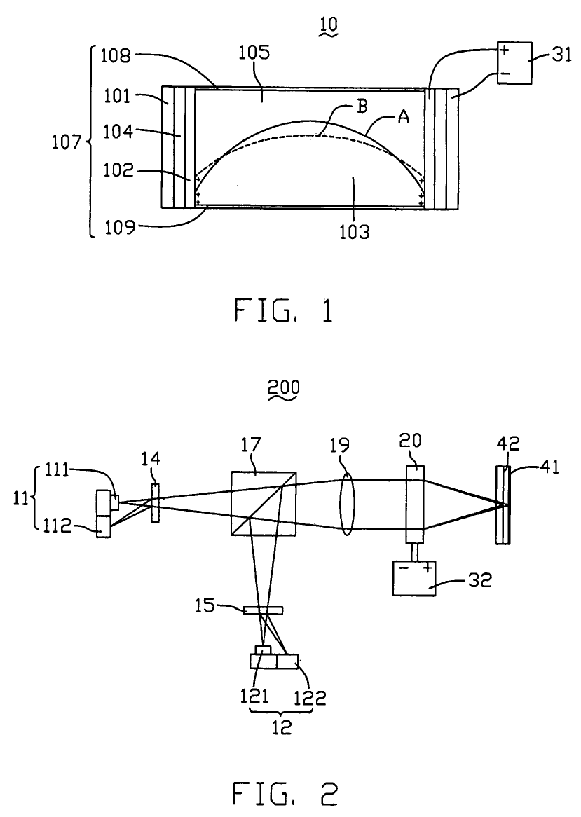

Referring to FIG. 2, an optical pickup device according to a second preferred embodiment of the present invention is shown. The optical pickup device 200 includes two light sources 111, 121, two holographic light splitters 14, 15, abeam splitter prism 17, a collimating lens 19, an object lens 20, and two photo detectors 112, 122. In order to decrease the bulk of the optical pickup device 200, the two photo detectors 112, 122 can be respectively integrated with the two light sources 111, 121 into two single optical transceiver assemblies 11, 12. The light source 111, the holographic light splitter 14, the beam splitter prism 17, the collimating lens 19, and the object lens 20 are aligned along a first direction in that order. The light source 121, the holographic light splitter 15 and the beam splitter prism 17 are aligned along a second direction substantially perpendicular to the first direction.

The light sources 111, 121 are adapted for emitting a first light beam with a first wavelength and a second light beam with a second wavelength, respectively. The light beams emitted from the light sources 111, 121 are eventually reflected by the respective recording medium, and subsequently transmit through the holographic light splitters 14, 15. The holographic light splitters 14, 15 are adapted for allowing direct propagation of the light beams emitted from the light sources 111, 121 therethrough, and for deflecting the light beams reflected by the optical recording medium to the two photo detectors 112, 122 respectively. The beam splitter prism 17 functions as a coupling element, and transmits or reflects incident light beams according to their respective wavelengths so that the light beams received from the light sources 111, 121 in different directions emit from the beam splitter prism 17 in the same first direction. The collimating lens 19 collimates the light beams into parallel light beams. The two photo detectors 112, 122 are adapted for detecting signals contained in the reflected light beams they receive via the holographic light splitters 14, 15, respectively. The object lens 20 is connected with a controller 32. The object lens 20 and the controller 32 are similar to the above-described object lens 10 and controller 31, respectively.

The optical pickup device 200 can be used for writing and/or reading information from different types of recording mediums, for example, a CD disk and a DVD disk. When the optical pickup device 200 writes information to and/or reads information from a CD, a selective voltage is applied to the object lens 20, and the numerical aperture of the object lens 20 is set at 0.45. The light source 111 emits a first light beam of 780 nm wavelength. The first light beam is transmitted through the holographic light splitter 14 and to the beam splitter prism 17. The beam splitter prism 17 can allow fill transmission of the first light beam of 780 nm wavelength therethrough. Then, the first light beam passes through the collimating lens 19 and becomes a first parallel light beam. The first parallel light beam passes through the object lens 20 and is focused on an information-recording layer 41 of a CD. Thus, the information of the CD is written and/or read. In addition, an original numerical aperture of the object lens 20 can be set at 0.45. Thus, when the optical pickup device 200 writes information to and/or reads information from the CD, no voltage needs to be applied to the object lens 20.

When the optical pickup device 200 writes information to and/or reads information from a DVD, a selective voltage is applied to the object lens 20, and the numerical aperture of the object lens 20 is set at 0.6. The light source 121 emits a second light beam of 650 nm wavelength. The second light beam transmits through the holographic light splitter 15 to the beam splitter prism 17. The beam splitter prism 17 can fully reflect the second light beam of 650 nm wavelength. Then, the second light beam passes through the collimating lens 19 and becomes a second parallel light beam. The second parallel light beam passes through the object lens 20 and is focused on an information-recording layer 42 of a DVD. Thus, the information of the DVD is written and/or read.

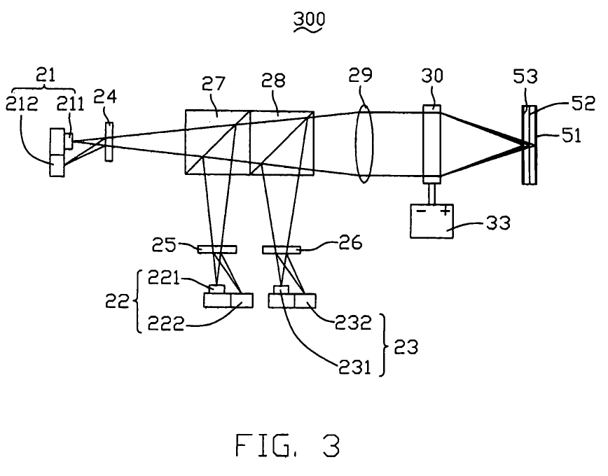

Referring to FIG. 3, an optical pickup device according to a third preferred embodiment of the present invention is shown. The optical pickup device 300 includes three light sources 211, 221, and 231, three holographic light splitters 24, 25, and 26, two beam splitter prisms 27, 28, a collimating lens 29, an object lens 30, and three photo detectors 212, 222, and 232. In order to decrease the bulk of the optical pickup device 300, the three photo detectors 212, 222, and 232 can be respectively integrated with the three light sources 211, 221, and 231 into three single optical transceiver assemblies 21, 22, and 23. The light source 211, the holographic light splitter 24, the beam splitter prisms 27, 28, the collimating lens 29 and the object lens 30 are aligned along a first direction in that order. The light source 221, the holographic light splitter 25 and the beam splitter prism 27 are aligned along a second direction substantially perpendicular to the first direction. The light source 231, the holographic light splitter 26 and the beam splitter prism 28 are aligned along the same second direction.

The light sources 211, 221, and 231 are adapted for emitting a first light beam with a first wavelength, a second light beam with a second wavelength, and a third light beam with a third wavelength respectively. The light beams emitted from the light sources 211, 221, and 231 are eventually reflected by the respective recording medium, and subsequently transmit through the holographic light splitters 24, 25, and 26. The holographic light splitters 24, 25, and 26 are adapted for allowing direct propagation of the light beams emitted from the light sources 211, 221, and 231 therethrough, and for deflecting the light beams reflected by the optical recording medium to the photo detectors 212, 222, and 232. The beam splitter prisms 27, 28 function as coupling elements, and transmit or reflect incident light beams according to their respective wavelengths so that the light beams received from the light sources 211, 221, and 231 in different directions emit from the beam splitter prism 27 in the same first direction. The collimating lens 29 collimates the light beams into parallel light beams. The three photo detectors 212, 222, and 232 are adapted for detecting signals contained in the reflected light beams they receive via the holographic light splitters 24, 25, and 26, respectively. The object lens 30 is connected with a controller 33. The object lens 30 and the controller 33 are similar to the above-described object lens 10 and controller 31, respectively.

In similar fashion to that described above in relation to the optical pickup device 200, the optical pickup device 300 can write information to and/or read information from an information recording-layer 51 of a CD, and write information to and/or read information from an information-recording layer 52 of a DVD. Further, when the optical pickup device 300 writes and/or reads information to or from a blu-ray disk, another selective voltage is applied to the object lens 30, and the numerical aperture of the object lens 30 is set at 0.85. The light source 231 emits a third light beam of 405nm wavelength. The third light beam transmits through the holographic light splitter 26 to the beam splitter prism 28. The beam splitter prism 28 can fully reflect the third light beam of 405 nm wavelength. Then, the third light beam passes through the collimating lens 29 and becomes a third parallel light beam. The third parallel light beam passes through the object lens 30 and is focused on an information-recording layer 53 of the blu-ray disk. Thus, the information of the blu-ray disk is written and/or read.

Compared with a conventional object lens, the present object lens has at least the following advantages. When different voltages are applied to the object lens, different numerical apertures of the object lens can be achieved. In addition, the object lens made from liquid material has low resistance to distortion. Thus, the present optical pickup device(s) using the object lens can accurately and quickly focus light beams on different types of recording mediums.

It is believed that the above-described embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An object lens, comprising:
a housing having an inner layer;
an electrically conductive liquid having an electro-wetting effect with respect to the inner layer of the housing; and
an electrically insulating liquid adjacent the electrically conductive liquid;
wherein, the electrically conductive liquid and the electrically insulating liquid are hermetically contained in the housing and form two layers along a central axis of the housing, the electrically conductive liquid is capable of changing its form when a voltage is applied to the electrically conductive layer whereby the object lens has a second numerical aperture, and the second numerical aperture is different from an original first numerical aperture of the object lens when there is no voltage applied to the electrically conductive layer.

2. The object lens as claimed in claim 1, wherein the electrically conductive liquid and the electrically insulating liquid have different optical properties.

3. The object lens as claimed in claim 2, wherein the electrically conductive liquid and the electrically insulating liquid have different refraction indexes.

4. The object lens as claimed in claim 1, wherein the electrically conductive liquid is an electrically conductive aqueous solution, and the electrically insulating liquid is an electrically insulating oily solution.

5. The object lens as claimed in claim 1, wherein the housing is columnar, and comprises a top wall, a bottom wall opposite to the top wall, and a sidewall, the sidewall comprises a hydrophobic electrically conductive layer, a middle layer, and a packaging layer in that order from an inside to an outside of the object lens, and the electro-wetting effect is formed between the electrically conductive liquid and the hydrophobic electrically conductive layer.

6. The object lens as claimed in claim 5, wherein the hydrophobic electrically conductive layer and the packaging layer respectively connect with an anode and a cathode of a controller, and a capacitive property exists between the hydrophobic electrically conductive layer and the packaging layer when a voltage is applied therebetween.

7. The object lens as claimed in claim 5, wherein the top wall and the bottom wall comprise glass material.

8. The object lens as claimed in claim 1, wherein an electrically conductive lubricant is sandwiched between the electrically conductive liquid and the electrically insulating liquid.

9. An optical pickup device compatible with plural optical recording mediums, comprising:
a first and a second light sources for emitting light beams with different wavelengths;
a first and a second photo detectors;
a first and a second light splitters for allowing direct propagation of the light beams emitted from the light sources therethrough, and for deflecting the light beams reflected by the optical recording medium to the first and second photo detectors respectively, wherein the first and the second photo detectors are adapted for detecting signals contained in the light beams they receive via the first and the second light splitters respectively;
a first beam splitter prism for transmitting or reflecting light beams according to their respective wavelengths; and
a liquid object lens defining at least two numerical apertures according to a controlled voltage applied thereto;
wherein, the first light source, the first light splitter, the first beam splitter prism and the object lens are aligned along a first direction in that order, the second light source, the second light splitter, and the first beam splitter prism are aligned along a second direction in that order, and the second direction is substantially perpendicular to the first direction.

10. The optical pickup device as claimed in claim 9, wherein the object lens comprises:
a housing having an inner layer;
an electrically conductive liquid having an electro-wetting effect relative to the inner layer of the housing; and
an electrically insulating liquid adjacent the electrically conductive liquid;
the electrically conductive liquid and the electrically insulating liquid are hermetically contained in the housing, and form two layers along a central axis of the housing, the electrically conductive liquid is capable of changing its form and a numerical aperture is defined by the object lens when a voltage is applied to the electrically conductive layer, the numerical aperture is different from an original numerical aperture of the object lens when there is no voltage applied to the electrically conductive layer.

11. The optical pickup device as claimed in claim 10, wherein the electrically conductive liquid and the electrically insulating liquid have different optical properties.

12. The optical pickup device as claimed in claim 11, wherein the electrically conductive liquid and the electrically insulating liquid have different refraction indexes.

13. The optical pickup device as claimed in claim 10, wherein the electrically conductive liquid is an electrically conductive aqueous solution, and the electrically insulating liquid is an electrically insulating oily solution.

14. The optical pickup device as claimed in claim 10, wherein the housing is columnar, and comprises a top wall, a bottom wall opposite to the top wall, and a columnar sidewall, the sidewall comprises a hydrophobic electrically conductive layer, a middle layer, and a packaging layer in that order from an inside to an outside of the object lens, and the electro-wetting effect is formed between the electrically conductive liquid and the hydrophobic electrically conductive layer.

15. The optical pickup device as claimed in claim 14, wherein the hydrophobic electrically conductive layer and the packaging layer respectively connect with an anode and a cathode of a controller, and a capacitive property exists between the hydrophobic electrically conductive layer and the packaging layer when a voltage is applied therebetween.

16. The optical pickup device as claimed in claim 14, wherein the top wall and the bottom wall comprise glass material.

17. The optical pickup device as claimed in claim 10, wherein an electrically conductive lubricant is sandwiched between the electrically conductive liquid and the electrically insulating liquid.

18. The optical pickup device as claimed in claim 9, further comprising a second beam splitter prism, a third light splitter, a third light source, and a third photo detector, wherein the second beam splitter prism is between the first beam splitter prism and the object lens, the third light source, the third light splitter, and the second beam splitter prism are aligned along the second direction, the third light source is for emitting light beams with a wavelength different from the wavelengths of the first and second light beams, and the third photo detector is adapted for detecting signals contained in reflected third light beams it receives via the third light splitter.

19. An optical pickup device compatible with plural optical recording mediums, comprising:
a first means for emitting light beams with different wavelengths corresponding to plural optical recording mediums respectively;
a second means for treating said light beams respectively for detecting signals contained in said light beams; and
an object lens installable in a transmissible path of said light beams between said second means and said plural optical recording mediums in order to optically alter said transmissible path of said light beams toward said plural optical recording mediums when said light beams pass through said object lens, said object lens comprising a first liquid-formed portion size-variable based on a control voltage applied thereon so as to vary a numerical aperture of said object lens when said object lens works to optically alter said transmissible path of said light beams.

20. The optical pickup device as claimed in claim 9, wherein said object lens comprises a second liquid-formed portion neighboring said first liquid-formed portion thereof and forming a movable interface therebetween so as to maintain an occupied volume of said object lens to be unchanged when said first liquid-formed portion is size-variable due to applying of said control voltage.
